(19) United States
(12) Patent Application Publication
(10) Pub. No.: US 2003/0142509 A1
(43) Pub. Date: Jul. 31, 2003

(54) Intermittently light emitting display apparatus

(76) Inventors: Hiroshi Tsuchiya, Osaka (JP); Yukihiro Noguchi, Motosu-gun (JP); Shoichiro Matsumoto, Oogaki-City (JP)

Correspondence Address: MCDERMOTT, WILL & EMERY, 600 13th Street, N.W., Washington, DC, 20005-3096, US

(21) Appl. No.: 10/330,028

(22) Filed: Dec. 27, 2002

(30) Foreign Application Priority Data
Dec. 28, 2001 (JP) JP2001-401620
Nov. 28, 2002 (JP) JP2002-345019

(51) Int. Cl. H02H 3/00; H02H 7/00; G02F 1/1335; F21V 7/04; H01L 33/00; A47F 3/00; H03H 9/00

(52) U.S. Cl. 362/555; 361/3; 349/69; 362/561

(57) ABSTRACT

As a scanning line turns high so as to turn on a first transistor, luminance data is set in a gate electrode of a second transistor and thus an organic light emitting diode emits light. As a signal at a control signal line becomes high so as to turn off a third transistor, the organic light emitting diode is cut off from a power supply line and turns off. A control circuit outputs a signal for the control signal line. Based on this signal outputted from the control circuit, on and off of the organic light emitting diode is controlled, so that intermittent light emission in the organic light emitting diode is realized.

### BACKGROUND OF THE INVENTION

1. Field of the Invention

The present invention relates to a display apparatus and more particularly to a technology for improving the visibility of active-matrix type display apparatuses.

2. Description of the Related Art

The use of notebook-type personal computers and portable terminals is spreading rapidly. Displays mainly used for such equipment are liquid crystal displays, but the display considered promising as a next-generation flat display panel is the organic EL (Electro Luminescence) display. And the active matrix drive system is central as a display method for such displays. The display using this system is called the active matrix display where a multiplicity of pixels are vertically and horizontally disposed in a matrix, and a switching element is provided for each pixel. Image data are written into each scanning line sequentially by the switching element.

The research and development for designing practical organic EL displays is now in the pioneer days, when a variety of pixel circuits are being proposed. One example of such circuits is a pixel circuit disclosed in Japanese Patent Application Laid-Open No. Hei11-219146, which will be briefly explained hereinbelow with reference to FIG. 17.

This circuit is comprised of a first transistor Tr50 and a second transistor Tr51 which are two n-channel transistors, an organic light emitting diode OLED 50 which is an optical element, a storage capacitance C50, a scanning line SL50 which sends a scanning signal, a power supply line Vdd50 and a data line DL50 through which luminance data is sent.

This circuit operates as follows. To write luminance data of the organic light emitting diode OLED 50, the scanning signal of the scanning line SL50 turns high and the first transistor Tr50 turns on, and luminance data inputted to the data line DL50 is set in both the second transistor Tr51 and the storage capacitance C50. Then, the current corresponding to the luminance data flows so as to cause the organic light emitting diode OLED 50 to emit light. When the scanning signal of the scanning line SL50 becomes low, the first transistor Tr50 turns off but voltage at the gate of the second transistor Tr51 is maintained, so that luminescence continues according to the set luminance data.

Here in the active matrix display the luminance data written to the drive element is being held in the scanning period of one frame and the light emission of the optical element is sustained, so that part of image object appears lingering on or blurred at the time of displaying fast moving pictures because there is much less degradation of light intensity caused compared to the CRT (Cathode Ray Tube) display.

### SUMMARY OF THE INVENTION

The present invention has been made in view of the foregoing circumstances and an object thereof is to provide a new circuitry where the visibility is improved. Another object thereof is to provide new circuitry that can reduce the occurrence of the residual image phenomenon. Still another object thereof is to provide a new circuitry which is controlled in accordance with respective characteristics of the optical elements in question.

A preferred embodiment according to the present invention relates to a display apparatus. And there is provided a display apparatus which includes a shutoff circuit provided between a current-driven optical element and a power supply and which controls the shutoff circuit at timing independent of timing that sets luminance data for the optical element, so that the optical element emits light intermittently. The shutoff circuit may be controlled by a control signal via a path different from a scanning signal that controls timing for setting luminance data to the optical element.

What may be assumed here as an “optical element” is an organic light emitting diode (also simply referred to as OLED hereinafter), but is not limited thereto. “Luminance data” means data concerning luminance or brightness information to be set in a drive element that drives the optical element, and is distinguished from the intensity of light emitted by the optical element. “Timing that sets luminance data for the optical element” is controlled by, for example, on and off of a switching element operated by the scanning signal. Moreover, what may be assumed here as a “drive element” or a “switching element” is, for example, an MOS (Metal Oxide Semiconductor) transistor or a TFT (Thin Film Transistor), but is not limited thereto. What may be assumed here as the above-mentioned “scanning signal” is a signal that controls luminance data setting timing, and is not limited thereto. The signal may be what is obtained in the formed of being branched out from the scanning signal. The signal line for the scanning signal is separately provided for each pixel line.

Another preferred embodiment according to the present invention relates also to a display apparatus. This apparatus includes: a shutoff circuit which shuts off a current-driven optical element from a power supply; and a control circuit which controls the shutoff circuit, wherein the control circuit controls the shutoff circuit at timing independent of timing that sets luminance data for the optical element, so that the optical element emits light intermittently. There may be provided a plurality of optical elements, constituting a pixel, which correspond to a plurality of colors. “A plurality of colors” may be three type of colors or RGB, for example. The control circuit may individually set on and off duty ratios for the respective plurality of optical elements. The shutoff circuit may include a drive element and a capacitance which stabilizes a hold state of luminance data set in the drive element, and the optical element may be put to an off state by varying a state of the luminance data via the capacitance.

It is to be noted that any arbitrary combination or rearrangement of the above-described structural components and so forth are all effective as and encompassed by the present embodiments.

Moreover, this summary of the invention does not necessarily describe all necessary features so that the invention may also be sub-combination of these described features.

### BRIEF DESCRIPTION OF THE DRAWINGS

FIG. 1 shows a circuit structure for a single pixel of a display apparatus according to a first embodiment of the present invention.

FIG. 2 shows a detailed circuit structure of a control circuit shown in FIG. 1.

FIG. 3 is a timing chart showing an operation of the control circuit shown in FIG. 2.

FIG. 4 shows a detailed structure of a control circuit according to a second embodiment of the present invention.

FIG. 5 is a timing chart showing an operation of the control circuit according to the second embodiment.

FIG. 6 shows a circuit structure for one pixel of a display apparatus according to a third embodiment of the present invention.

FIG. 7 shows a circuit structure for four pixels of a display apparatus according to a fourth embodiment.

FIG. 8 shows a detailed structure of a control circuit according to the fourth embodiment.

FIG. 9 is a timing chart showing an operation of the control circuit according to the fourth embodiment.

FIG. 10 shows a circuit structure for a single pixel of a display apparatus according to a fifth embodiment.

FIG. 11 shows a circuit structure in which the circuit shown in FIG. 1 further includes a bypass circuit therein.

FIG. 12 shows a circuit structure in which the circuit shown in FIG. 6 further includes a bypass circuit therein.

FIG. 13 shows a multi-layer structure of an organic light emitting diode.

FIG. 14 shows a multi-layer structure having a reversed structure compared to the organic light emitting diode shown in FIG. 13.

FIG. 15 shows a circuit structure for a pixel where the anode and cathode electrodes of the organic light emitting diode shown in the pixel circuit of FIG. 11 are replaced with the cathode and anode electrodes thereof, respectively.

FIG. 16 shows a circuit structure for a pixel where the anode and cathode electrodes of the organic light emitting diode shown in the pixel circuit of FIG. 12 are replaced with the cathode and anode electrodes thereof, respectively.

FIG. 17 shows a circuit structure for a pixel of a display apparatus according to the conventional practice.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the following embodiments, an active matrix organic EL (Electro Luminescence) display is assumed as a display apparatus. A novel circuitry featuring an improved visibility will be proposed hereinbelow.

First Embodiment

According to a first embodiment of the present invention, a path between an optical element and power supply is separated by a shutoff circuit so as to turn the optical element off temporarily whereby intermittent light emission is realized. A positive effect of intermittent light emission of an optical element in eliminating phenomena, such as line flicker and motion blur, which often occur when quickly moving pictures are displayed by an active matrix display apparatus is discussed in an article entitled “Requirements for LCD to Gain High Moving Image Quality—Improvement of Quality Degraded by Hold-Type Display” by Taiichiro Kurita (AM-LCD2000). The display apparatus according to this embodiment improves visibility by intermittent display.

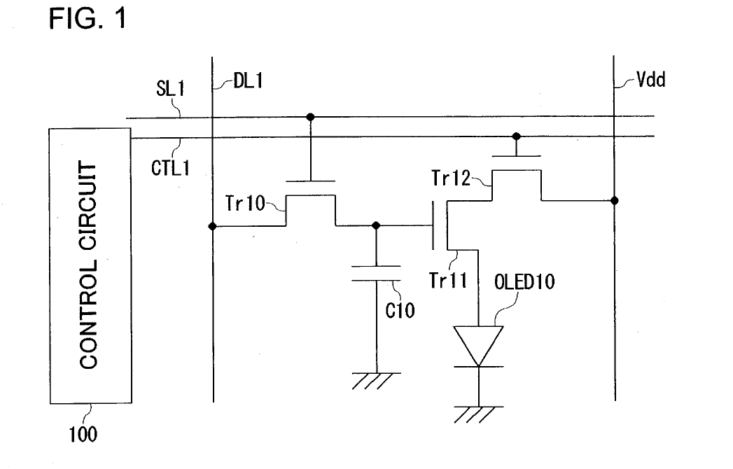

FIG. 1 shows a circuit structure for a single pixel of a display apparatus according to the first embodiment. This pixel is comprised of a first transistor Tr10 which serves as a switching element, a second transistor Tr11 which serves as a drive element, a third transistor Tr12 which serves as a shutoff circuit, a capacitor C10 which serves as a storage capacitance, and an OLED 10 which serves as an optical element.

The first transistor Tr10 operates as a switch which controls luminance data write timing of the OLED 10. The second transistor Tr11 operates as an element which drives the OLED 10. The third transistor Tr12 operates as a switch which cuts off the OLED 10 from power supply line Vdd.

The power supply line Vdd supplies voltage which causes the OLED 10 to emit light. A data line DL1 sends a signal of luminance data to be set in the second transistor Tr11. A scanning line SL1 sends a scanning signal which activates the first transistor Tr10 at the luminance data write timing of the OLED 10. A control signal line CTL1 sends a control signal which activates the third transistor Tr12 at the timing to cut off the OLED 10 from the power supply line Vdd. A control circuit 100 outputs a control signal to the control signal line CTL1 which is a path different from the scanning line SL1. The structure of the control circuit 100 will be described in detail later.

The first to third transistors Tr10, Tr11 and Tr12 are each an n-channel transistor. A gate electrode of the first transistor Tr10 is connected to the scanning line SL1, a drain electrode (or a source electrode) of the first transistor Tr10 is connected to the data line DL1, and the source electrode (or the drain electrode) of the first transistor Tr10 is connected to a gate electrode of the second transistor Tr11. One end of the capacitor C10 is connected to a path between the source electrode (or the drain electrode) of the first transistor Tr10 and the gate electrode of the second transistor Tr11, whereas the other end of the capacitor C10 is set at the same potential as ground potential.

A drain electrode of the second transistor Tr11 is connected to a source electrode of the third transistor Tr12, and a source electrode of the second transistor Tr11 is connected to an anode electrode of the OLED 10. A gate electrode of the third transistor Tr12 is connected to the control signal line CTL1, and a drain electrode of the third transistor Tr12 is connected to the power supply line Vdd. A cathode electrode of the OLED 10 is set at the same potential as ground potential.

An operation procedure to be realized by the above-described structure will be explained hereinbelow. First, as a scanning signal in the scanning line SL1 becomes high, the first transistor Tr10 turns on, thereby causing a control signal in the control signal line CTL1 to become high and the third transistor Tr12 to turn on, with the result that the source electrode of the second transistor Tr11 conducts to the power supply line Vdd. The potential at the data line DL1 becomes the same as the potential at a gate potential of the second transistor Tr11, so that luminance data flowing to the data line DL1 is set in the gate electrode of the second transistor Tr11. This causes a current corresponding to the gate-source voltage in the second transistor Tr11 to flow between the power supply line Vdd and an anode electrode of the OLED 10, and consequently the OLED 10 emits light at an intensity corresponding to the amount of the current having flowed thereto.

Even when the first transistor Tr10 has turned off with the scanning signal in the scanning line SL1 being in a low state, the luminance data is held floating between the source electrode (or the drain electrode) of the first transistor Tr10 and the gate electrode of the second transistor Tr11, so that the light emission of the OLED 10 according to said luminance data is maintained. The capacitor C10 functions to stabilize the hold state of the luminance data.

As the control signal in the control signal line CTL1 becomes low, the third transistor Tr12 turns off, thereby cutting off the OLED 10 from the power supply line Vdd. Hence, the OLED 10 turns off irrespective of the luminance data set in the gate electrode of the second transistor Tr11. The OLED 10 remains off until a next scanning timing when the scanning signal in the scanning line SL1 and the control signal in the control signal line CTL1 become high.

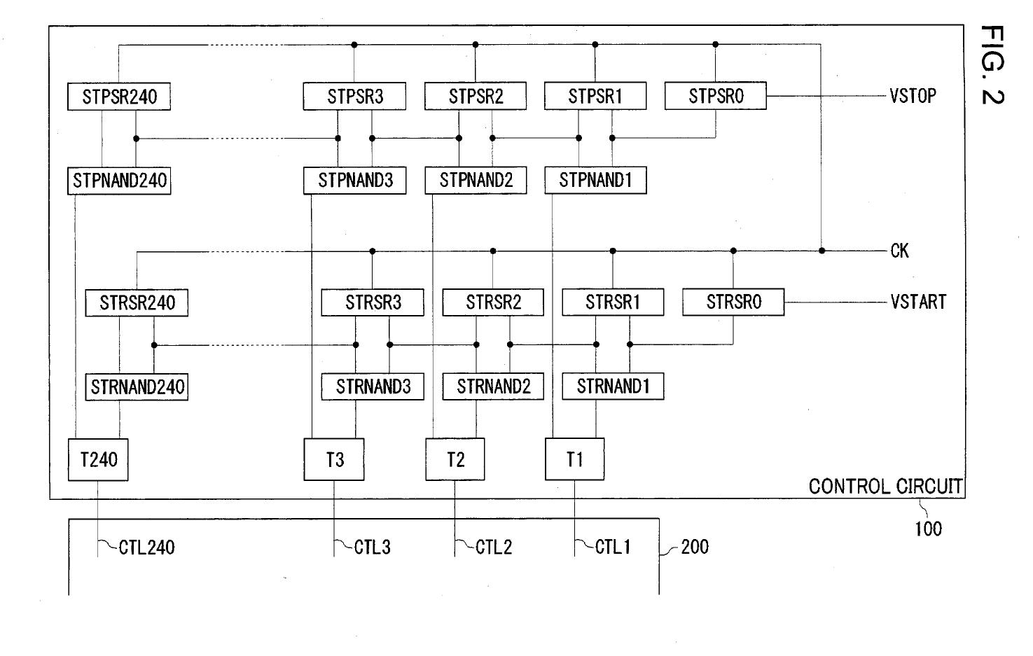

FIG. 2 shows a detailed circuit structure of a control circuit. A control circuit 100 has a number, corresponding to the number of pixel lines contained in a pixel region 200, of a set of a starting NAND circuit and a starting shift register, which determine the timing of switching a control signal from low to high, and a set of a stopping NAND circuit and a stopping shift register, which determine the timing of switching a control signal from high to low. Since the number of pixel lines according to this embodiment is 240, the control circuit 100 contains first to 240th starting NAND circuits STRNAND1 to STRNAND240 and 0th to 240th starting shift registers STRSR0 to STRSR240, and first to 240th stopping NAND circuits STPNAND1 to STPNAND240 and 0th to 240th stopping shift registers STPSR0 to STPSR240.

The control circuit 100 further includes first to 240th toggle circuits T1 to T240, which generate and output control signals using signals inputted from their respective starting NAND circuits and stopping NAND circuits. The first to 240th toggle circuits T1 to T240 output control signals to first to 240th control signal lines CTL1 to CTL240, respectively. A start signal VSTART is inputted to the 0th starting shift register STRSR0, whereas a stop signal VSTOP is inputted to the 0th stopping shift register STPSR0. A clock signal CK is inputted to each of the shift registers.

An operation of the control circuit 100 that implements the above-described structure will be described hereinbelow. Suppose first that the start signal VSTART and the stop signal VSTOP are turned high for two clock cycles at the rate of once every 240 clock signals. After the start signal VSTART has become high, a signal outputted from the 0th starting shift register STRSR0 becomes high at clock timing. This signal is inputted to the first starting shift register STRSR1 and the first starting NAND circuit STRNAND1. A signal outputted from the first starting shift register STRSR1 to which the high signal has been inputted goes high at clock timing. This signal is inputted to the first and second starting NAND circuits STRNAND1 and STRNAND2 and the second starting shift register STRSR2.

Here, since an output pulse from each of the shift registers has a cycle of two clock signals, the first starting NAND circuit STRNAND1 outputs a pulse which goes low when both the outputs from the first and second starting shift registers STRSR1 and STRSR2 go high. In another form of the embodiment, the structure may be such that an AND circuit is used in place of the starting NAND circuit. In still another form of the embodiment, it may be so structured that provided the cycle of an output pulse from the starting shift register is short, the output signal from the starting shift register is inputted directly to the toggle circuit without the use of either the NAND circuit or the AND circuit.

After the stop signal VSTOP has gone high, a signal outputted from the 0th stopping shift register STPSR0 goes high at clock timing. This signal is inputted to the first stopping shift register STPSR1 and the first stopping NAND circuit STPNAND1. A signal outputted from the first stopping shift register STPSR1 to which the high signal has been inputted becomes high at the next clock timing. This signal is inputted to the first and second stopping NAND circuits STPNAND1 and STPNAND2 and the second stopping shift register STPSR2. The first stopping NAND circuit STPNAND1 outputs a pulse which goes low when both the outputs from the first and second stopping shift registers STPSR1 and STPSR2 go high. In another form of the embodiment, the structure may be such that an AND circuit is used in place of the stopping NAND circuit STPNAND. In still another form of the embodiment, it may be so structured that provided the cycle of an output pulse from the stopping shift register is short, the output signal from the stopping shift register is inputted directly to the toggle circuit without the use of either the NAND circuit or the AND circuit.

The control signal outputted by the first toggle circuit T1 switches to a high when the signal inputted from the first starting NAND circuit STRNAND1 has gone low and thereafter switches to a low when the signal inputted from the first stopping NAND circuit STPNAND1 has turned low.

The second to 240th starting shift registers STRSR2 to STRSR240 operate the same way as the first starting shift register STRSR1. The second to 240th starting NAND circuits STRNAND2 to STRNAND240 operate the same way as the first starting NAND circuit STRNAND1. The second to 240th stopping shift registers STPSR2 to STPSR24 operate the same way as the first stopping shift register STPSR1. The second to 240th stopping NAND circuits STPNAND2 to STPNAND240 operate the same way as the first stopping NAND circuit STPNAND1. The second to 240th toggle circuits T2 to T240 operate the same way as the first toggle circuit T1. Through the operations as described above, control signals, which go high at different timings for different pixel lines, are outputted to the first to 240th control signal lines CTL1 to CTL240.

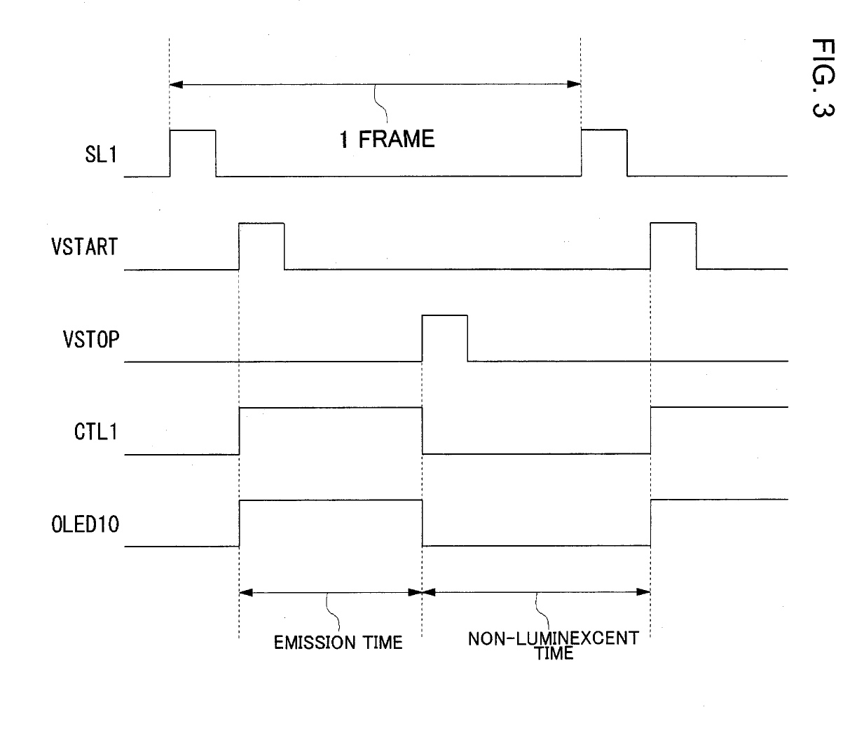

FIG. 3 is a timing chart showing an operation of the control circuit 100. In the timing chart, where the horizontal axis represents time, the high and low states of the start signal VSTART, the stop signal VSTOP, the control signal in the control signal line CTL1 and the scanning signal in the scanning signal line SL1 are shown in relation to light emission states of the OLED 10. It is to be noted that although the OLED 10 emits light at intensity according to the luminance data, the on and off emission states thereof are shown simply by a high and a low in FIG. 3. The interval between the rises of the scanning signal in the scanning signal line SL1 is the scanning time for one frame.

As the scanning signal in the scanning line SL1 becomes high, the first transistor Tr10 turns on, thereby causing the luminance data to be set in the second transistor Tr11. As the start signal VSTART turns high, the control signal in the control signal line CTL1 turns high, too, and the third transistor Tr12 turns on. The OLED 10 conducts to the power supply line Vdd and emits light at intensity corresponding to the luminance data. As the stop signal VSTOP becomes high, the control signal in the control signal line CTL1 turns low, thereby turning off the OLED 10. The non-luminescent state of the OLED 10 maintained until the scanning signal in the scanning line SL1 goes high the next time and then the start signal VSTART goes high, too.

As shown in FIG. 3, the period from the rise of the start signal VSTART to the rise of the stop signal VSTOP, namely, the period during which the control signal in the control signal line CTL1 is high, is the light emission time of the OLED 10, whereas the period from the rise of the stop signal VSTOP to the rise of the start signal VSTART, namely, the period during which the control signal in the control signal line CTL1 is low, is the non-luminescent time of the OLED 10. The control signal in the control signal line CTL1 is controlled by the timing independent of the timing for setting luminance data, thus realizing the intermittent light emission of the OLED 10.

The structure thus implemented in this embodiment as described above improves the visibility of moving image display by reducing phenomena, such as line flicker and motion blur, which often occur when moving pictures are displayed by the active matrix display apparatus using a current-driven optical element. Moreover, the occurrence of the residual image phenomenon is reduced by eliminating electric charge remaining in the optical element.

Second Embodiment

A second embodiment of the present invention differs from the first embodiment in that the control circuit 100 further outputs scanning signals. Hereinbelow, the features of the second embodiment will be described with emphasis on the differences of a control circuit 100 from the first embodiment.

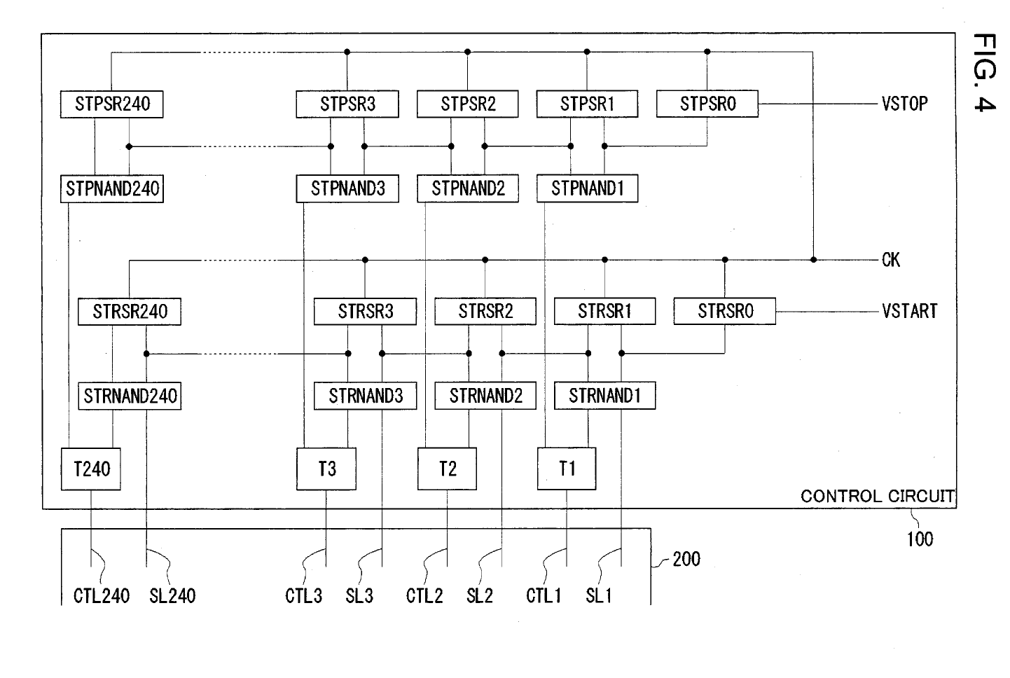

FIG. 4 shows a detailed structure of the control circuit 100 according to a second embodiment. The first to 240th starting NAND circuits STRNAND1 to STRNAND240 output the same signals as those outputted to the first to 240th toggle circuits T1 to T240 to the first to 240th scanning signal lines SL1 to SL240 as the first to 240th scanning signals. The scanning signal in the first scanning line is utilized in the on-off control for setting luminance data by being inputted to the gate electrode of the first transistor Tr10 (not shown). Similarly, the scanning signals in the second to 240th scanning lines SL2 to SL240 are utilized in the on-off control for setting luminance data at the other pixel lines which are respectively corresponding thereto.

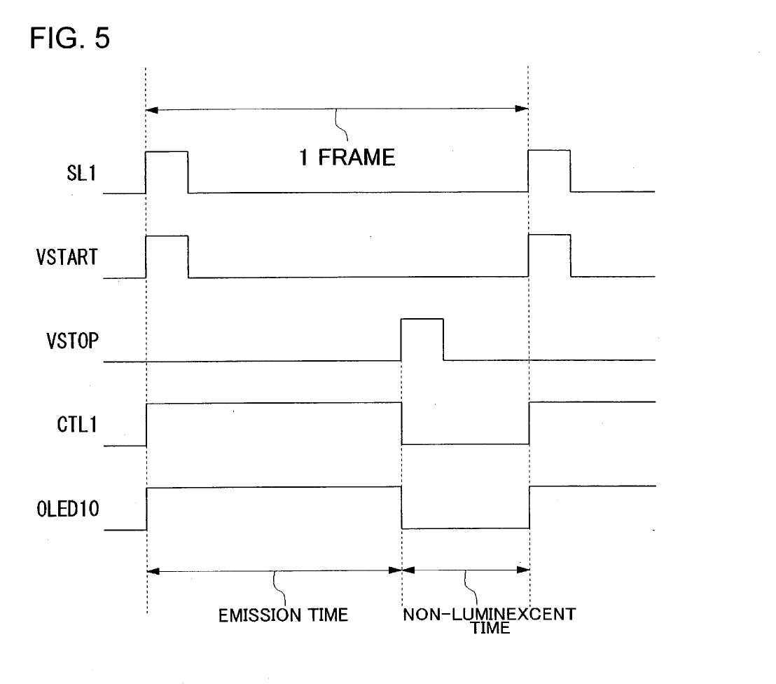

FIG. 5 is a timing chart showing an operation of the control circuit according to the second embodiment. As the start signal VSTART becomes high, the scanning signal in the first scanning line SL1 also turns high and at the same time the control signal in the first control signal line CTL1 turns high, too. This causes the first transistor Tr10 to turn on, thereby setting luminance data in the second transistor Tr11. Then as the third transistor Tr12 turns on, the OLED 10 conducts to the power supply line Vdd and emits light at intensity corresponding to the luminance data.

As the stop signal VSTOP turns on and the control signal in the first control signal line CTL1 turns low, the third transistor Tr12 turns off and the OLED 10 turns off. Then the non-luminescent state of the OLED 10 is maintained until the scanning signal in the first scanning line SL1 and the start signal VSTART go high.

Third Embodiment

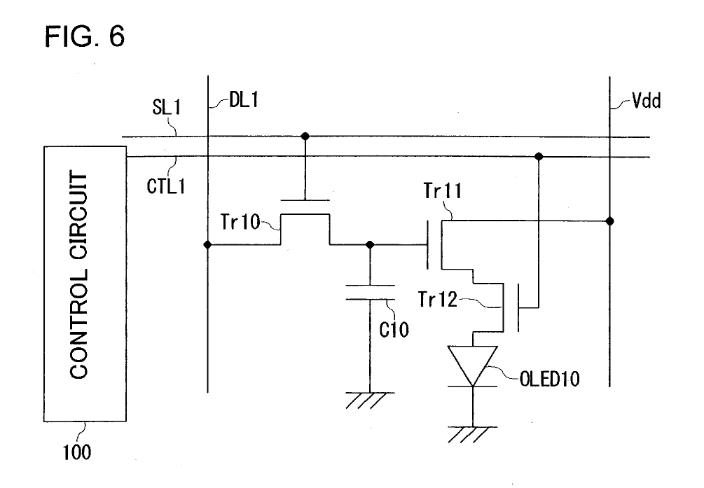

FIG. 6 shows a circuit structure for one pixel of a display apparatus according to a third embodiment. This embodiment differs from the first embodiment in that the third transistor Tr12 is positioned between the second transistor Tr11 and the OLED 10. That is the source electrode of the third transistor Tr12 is connected to the anode electrode of the OLED 10, and the drain electrode of the third transistor Tr12 is connected to the source electrode of the second transistor Tr11. The same way as in the first embodiment, the third transistor Tr12 turns on when the control signal in the control signal line CTL1 goes high and turns off when the control signal in the control signal line CTL1 goes low. These operations and timings are the same as those in the first embodiment.

Fourth Embodiment

A fourth embodiment differs from the first embodiment in that three control signal lines are provided for each of the pixel lines in such a way as to correspond to R (red), G (green) and B (blue) pixels, respectively. According to this structure, the OLED can be cut off from the power supply line at individual timings for R, G and B, so that the duty ratios may be set individually for the on and off of the OLED. As a result thereof, the balance between the three colors R, G and B can be adjusted. Moreover, this facility can cope with the difference in degradation rate caused by the difference in material of OLEDs utilized for R, G and B.

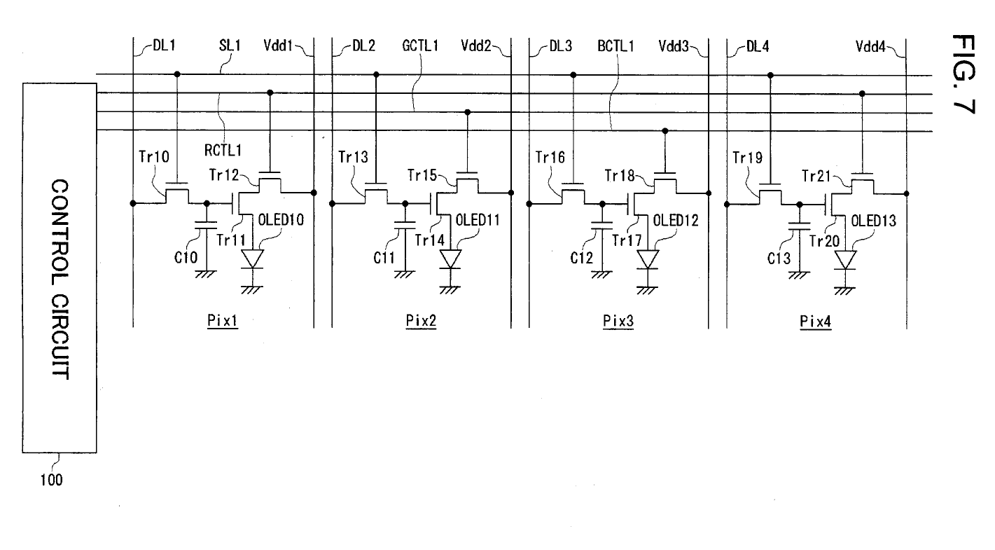

FIG. 7 shows a circuit structure for four pixels of a display apparatus according to a fourth embodiment. Shown in FIG. 7 is the circuit for four pixels, namely, pixels Pix1 to Pix4. The pixels Pix1 and Pix4 emit red light, the pixel Pix2 emits green light, and the pixel Pix3 emits blue light. First to fourth power supply lines Vdd1 to Vdd4 supply voltage to their respective pixels Pix1 to Pix4, whereas first to fourth data lines DL1 to DL4 input luminance data to their respective pixels Pix1 to Pix4. A first scanning line SL1 inputs a scanning signal to the pixels Pix1 to Pix4.

A red control signal line RCTL1 inputs a red control signal to the pixels Pix1 and Pix4, a green control signal line GCTL1 inputs a green control signal to the pixel Pix2, and a blue control signal line BCTL1 inputs a blue control signal to the pixel Pix3. First to third transistors Tr10, Tr11 and Tr12, a first capacitor C10 and a first OLED 10, which are all contained in the pixel Pix1, function the same way respectively as with the structure with the same reference numerals in the first embodiment. Fourth to sixth transistors Tr13, Tr14 and Tr15, a second capacitor C11 and a second OLED 11, which are all contained in the pixel Pix2, are of the same structure as the corresponding first to third transistors Tr10, Tr11 and Tr12, the first capacitor C10 and the first OLED 10, respectively.

Seventh to ninth transistors Tr16, Tr17 and Tr18, a third capacitor C12 and a third OLED 12, which are all contained in the pixel Pix3, are also of the same structure as the corresponding first to third transistors Tr10, Tr11 and Tr12, the first capacitor C10 and the first OLED 10, respectively. Tenth to twelfth transistors Tr19, Tr20 and Tr21, a fourth capacitor C13 and a fourth OLED i3, which are all contained in the pixel Pix4, are also of the same structure as the corresponding first to third transistors Tr10, Tr11 and Tr12, the first capacitor C10 and the first OLED 10, respectively.

A control circuit 100 turns off the pixels Pix1 and Pix4, the pixel Pix2, and the pixel Pix3 at their respective timings by raising the red control signal, the green control signal and the blue control signal in the red control signal line RCTL1, the green control signal line GCTL1 and the blue control signal line BCTL1 to a high at their respective timings.

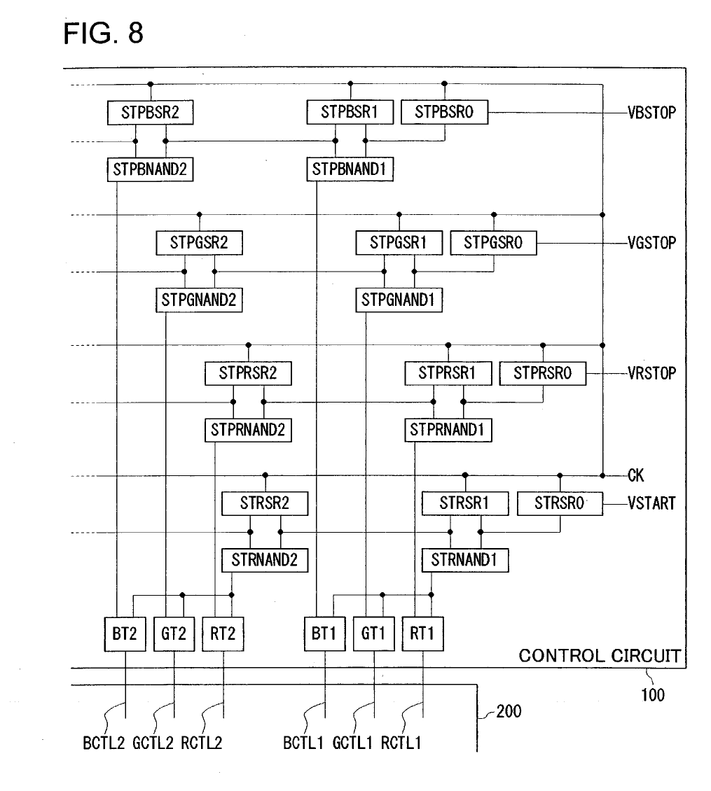

FIG. 8 shows a detailed structure of a control circuit according to the fourth embodiment. The control circuit 100 shown in FIG. 8 differs from the one according to the first embodiment in that the control signals for R, G and B, respectively, are outputted by the use of one start signal and three stop signals. The control circuit 100 includes 0th to 240th starting shift registers STRSR0 to STRSR240, first to 240th starting NAND circuits STRNAND1 to STRNAND240, 0th to 240th red stopping shift registers STPRSR0 to STPRSR240, first to 240th red stopping NAND circuits STPRNAND1 to STPRNAND240, 0th to 240th green stopping shift registers STPGSR0 to STPGSR240, first to 240th green stopping NAND circuits STPGNAND1 to STPGNAND240, 0th to 240th blue stopping shift registers STPBSR0 to STPBSR240, first to 240th blue stopping NAND circuits STPBNAND1 to STPBNAND240, first to 240th red toggle circuits RT1 to RT240, first to 240th green toggle circuits GT1 to GT240, and first to 240th blue toggle circuits BT1 to BT240.

A start signal VSTART is inputted to the 0th starting shift register STRSR0, a red stop signal VRSTOP is inputted to the 0th red stopping shift register STPRSR0, a green stop signal VGSTOP is inputted to the 0th green stopping shift register STPGSR0, and a blue stop signal VBSTOP is inputted to the 0th blue stopping shift register STPBSR0. A clock signal CK is inputted to each of the shift registers. The start signal VSTART, the red stop signal VRSTOP, the green stop signal VGSTOP and the blue stop signal VBSTOP are raised to a high once every 240 clock pulses at their respective timings.

An operation of the control circuit 100 realized by the above-described structure will be described hereinbelow. The 0th to 240th starting shift registers STRSR0 to STRSR240 and the first to 240th starting NAND circuits STRNAND1 to STRNAND240 operate the same way as those having structures indicated with the same reference numerals in the first embodiment. Namely, as the start signal VSTART goes high, the signal outputted from the first starting NAND circuit STRNAND1 goes low at clock timing, and then the signal outputted from the second starting NAND circuit STRNAND2 goes at the next clock timing. This is repeated sequentially as far as the 240th starting NAND circuit STRNAND240.

The signal outputted by the first starting NAND circuit STRNAND1 is inputted to each of the first red toggle circuit RT1, the first green toggle circuit GT1 and the first blue toggle circuit BT1. Similarly, the signals outputted by the second to 240th starting NAND circuits STRNAND2 to STRNAND240 are inputted correspondingly to the second to 240th red toggle circuits RT2 to RT240, the second to 240th green toggle circuits GT2 to GT240 and the second to 240th blue toggle circuits BT2 to BT240, respectively.

The 0th to 240th red stopping shift registers STPRSR0 to STPRSR240 and the first to 240th red stopping NAND circuits STPRNAND1 to STPRNAND240 operate the same way as the 0th to 240th stopping shift registers STPSR0 to STPSR240 and the first to 240th stopping NAND circuits STPNAND1 to STPNAND240 in the first embodiment. Namely, as the red stop signal VRSTOP goes high, the signal outputted from the first red stopping NAND circuit STPRNAND1 goes low at clock timing, and then the signal outputted from the second red stopping NAND circuit STPRNAND2 goes low at the next clock timing. This is repeated sequentially as far as the 240th red stopping NAND circuit STPRNAND240.

The signals outputted by the first to 240th red stopping NAND circuits STPRNAND1 to STPRNAND240 are inputted to the first to 240th red toggle circuits RT1 to RT240, respectively. The red control signal outputted by the first red toggle circuit RT1 switches to a high when the signal inputted from the first starting NAND circuit STRNAND1 goes low, and thereafter switches to a low when the signal inputted from the first red stopping NAND circuit STPRNAND1 goes low. Namely, the red control signal also goes high when the start signal VSTART goes high and thereafter goes low when the red stop signal VRSTOP goes high. In sequence thereafter, the second to 240th red control signals are also switched on and off. The first to 240th red control signals are outputted to the first to 240th red control signal lines RCTL1 to RCTL240, respectively.

The 0th to 240th green stopping shift registers STPGSR0 to STPGSR240 and the 0th to 240th blue stopping shift registers STPBSR0 to STPBSR240 operate the same way as the 0th to 240th red stopping shift registers STPRSR0 to STPRSR240 at their respective timing. The first to 240th green stopping NAND circuits STPGNAND1 to STPGNAND240 and the first to 240th blue stopping NAND circuits STPBNAND1 to STPBNAND240 operate the same way as the first to 240th red stopping NAND circuits STPRNAND1 to STPRNAND240 at their respective timings. The first to 240th green toggle circuits GT1 to GT240 and the first to 240th blue toggle circuits BT1 to BT240 operate the same way as the first to 240th red toggle circuits RT1 to RT240 at their respective timings.

The first to 240th green toggle circuits GT1 to GT240 output green control signals respectively to the first to 240th green control signal lines GCTL1 to GCTL240. The first to 240th blue toggle circuits BT1 to BT240 output blue control signals respectively to the first to 240th blue control signal lines BCTL1 to BCTL240.

The first red control signal, the first green control signal and the first blue control signal go high at the same timing when the start signal VSTART goes high, and go low at their individual timings when the red stop signal VRSTOP, the green stop signal VGSTOP and the blue stop signal VBSTOP go high, respectively. The second to 240th red control signals, the second to 240th green control signals and the second to 240th blue control signals also go high at the same timing and are switched to a low at their respective timings. Namely, the high and low of the control signals are switched according to the duty ratios for R, G and B.

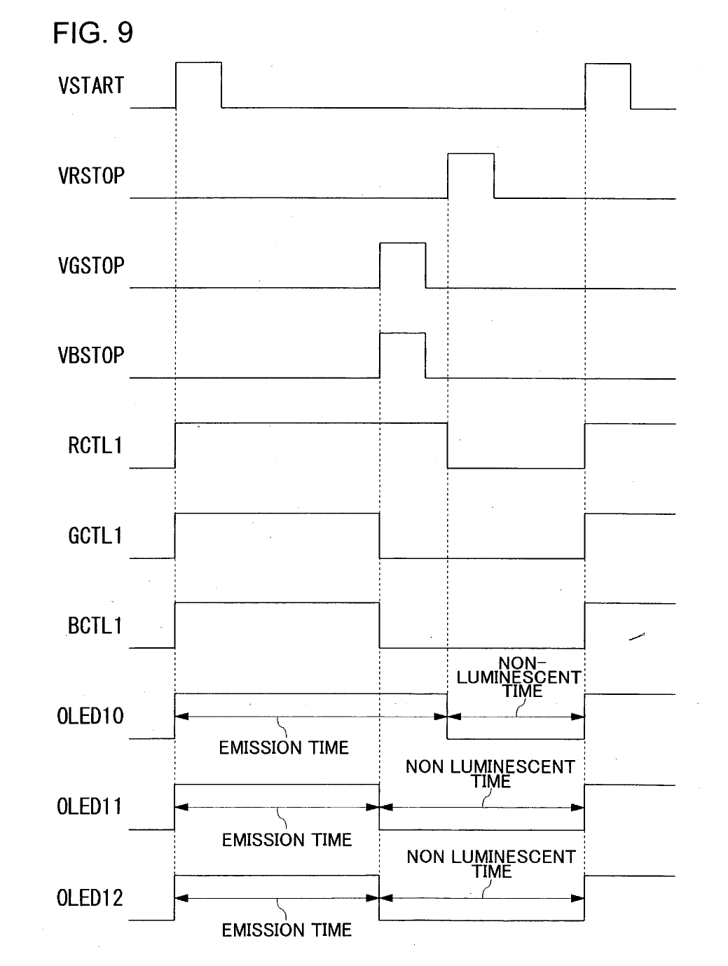

FIG. 9 is a timing chart showing the operation of the control circuit according to the fourth embodiment. This timing chart differs from the one in FIG. 3 in that the stop signals go high at their respective timings for R, G and B, the control signals switch between high and low at their respective timings for R, G and B, and the emission time and non-luminescent time of the organic light emitting diodes are set respectively for R, G and B.

As the start signal VSTART goes high, the control signals in the red control signal line RCTL1, the green control signal line GCTL1 and the blue control signal line BCTL1 go high almost simultaneously, and the red OLED 10, the green OLED 11 and the blue OLED 12 emit light, respectively. As the green stop signal VGSTOP and the blue stop signal VBSTOP go high at the same timing, the control signals in the green control signal line GCTL1 and the blue control signal line BCTL1 switch to a low almost simultaneously, and the green OLED 11 and the blue OLED 12 turn off. As the red stop signal VRSTOP goes high, the control signal in the red control signal line RCTL1 switches to a low, and the red OLED 10 turns off.

Fifth Embodiment

A fifth embodiment differs from the first embodiment in that a shutoff circuit between an organic light emitting diode and a power supply line is structured by a combination of transistors and a capacitor.

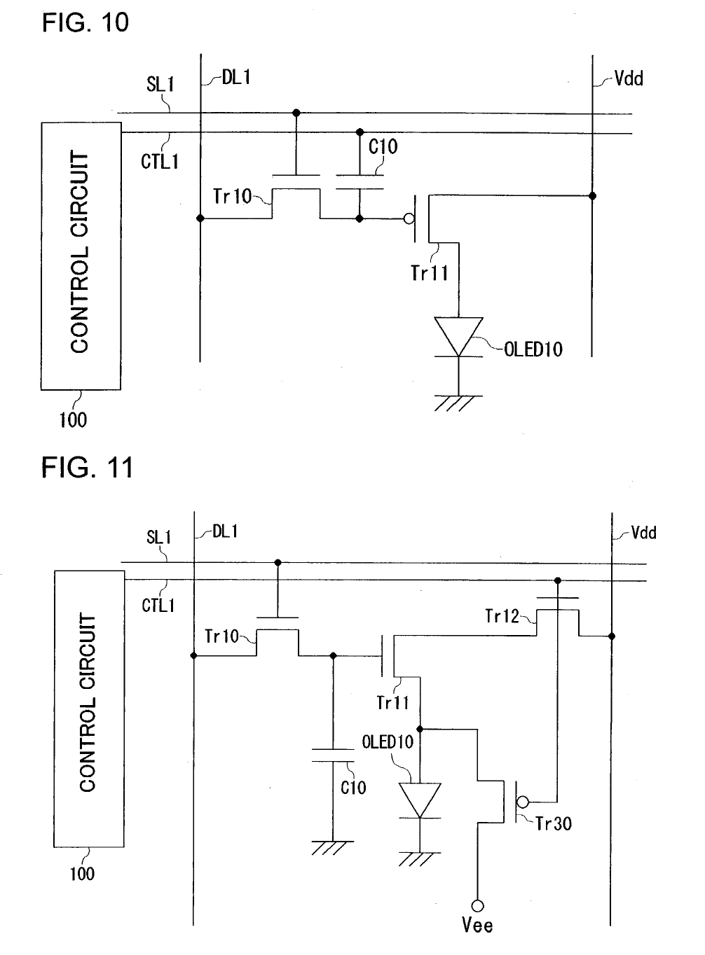

FIG. 10 shows a circuit structure for a single pixel of a display apparatus according to the fifth embodiment. This pixel includes a first transistor Tr10 which serves as a switching element, a second transistor Tr11 which serves as a drive element, a capacitor C10 which serves as a storage capacitance, and an OLED 10 which serves as an optical element. The first transistor Tr10 is an n-channel transistor, and the second transistor Tr11 is a p-channel transistor.

A gate electrode of the first transistor Tr10 is connected to a scanning line SL1, a source electrode (or a drain electrode) of the first transistor Tr10 is connected to a data line DL1, and the drain electrode (or the source electrode) of the first transistor Tr10 is connected to a gate electrode of the second transistor Tr11. A source electrode of the second transistor Tr11 is connected to a power supply line Vdd, and a drain electrode of the second transistor Tr11 is connected to an anode electrode of the OLED 10. A cathode electrode of the OLED 10 is set at the same potential as ground potential. One end of the capacitor C10 is connected to a path between the drain electrode (or the source electrode) of the first transistor Tr10 and the gate electrode of the second transistor Tr11, whereas the other end of the capacitor C10 is connected to a control signal line CTL1.

As the scanning signal in the scanning line SL1 goes high, the first transistor Tr10 turns on, which causes the potential at the data line DL1 to become the same as the potential at the gate potential of the second transistor Tr11, so that luminance data flowing to the data line DL1 is set in the gate electrode of the second transistor Tr11. As a current corresponding to the gate-source voltage in the second transistor Tr11 flows from the power supply line Vdd to the OLED 10, the OLED 10 emits light at an intensity that corresponds to the luminance data.

Even when the first transistor Tr10 has turned off with the scanning signal in the scanning line SL1 low, the luminance data is held in the drain electrode of the second transistor Tr11, so that a light emission state of the OLED 10 is maintained. Here, as the control signal in the control signal line CTL1 goes high, the luminance data is held floating between the drain electrode (or the source electrode) of the first transistor Tr10 and the gate electrode of the second transistor Tr11, so that the potential at the gate of the second transistor Tr11 is pushed up via the capacitor C10. As a result, the gate-source voltage of the second transistor Tr11 drops to a small value, thereby cutting off the path between the OLED 10 and the power supply line Vdd. In other words, the capacitor C10 and the second transistor Tr11 function as a shutoff circuit to turn off the OLED 10.

The scanning signal in the scanning line SL1 and the control signal in the control signal line CTL1 are thus used to control the light emission and non-luminescent timings of the OLED, and hence the intermittent light emission of the OLED 10 can be realized the same way as in the first embodiment.

The present invention has been described based on embodiments which are only exemplary. It is understood by those skilled in the art that there exist other various modifications to the combination of each component and process described above and that such modifications are encompassed by the scope of the present invention. Such modifications will be described hereinbelow

The transistors Tr10, Tr13, Tr16 and Tr19, which are utilized as switching elements for writing luminance data with the gate electrode thereof connected to the scanning line, may be each structured by a combination of a plurality of transistors, and their capabilities may be structured by an arbitrary combination thereof.

In the preferred embodiments above, the first to twelfth transistors Tr10, Tr11, Tr12, Tr13, Tr14, Tr15, Tr16, trl7, Tr18, Tr19, Tr20, Tr21 are all n-channel transistors. However, at least one of these transistors may be of p-channel structure.

In the preferred embodiments above, forward bias is applied to the OLED. However, configuration may be such that reverse bias is applied in modified examples as shown in FIGS. 11 to 16.

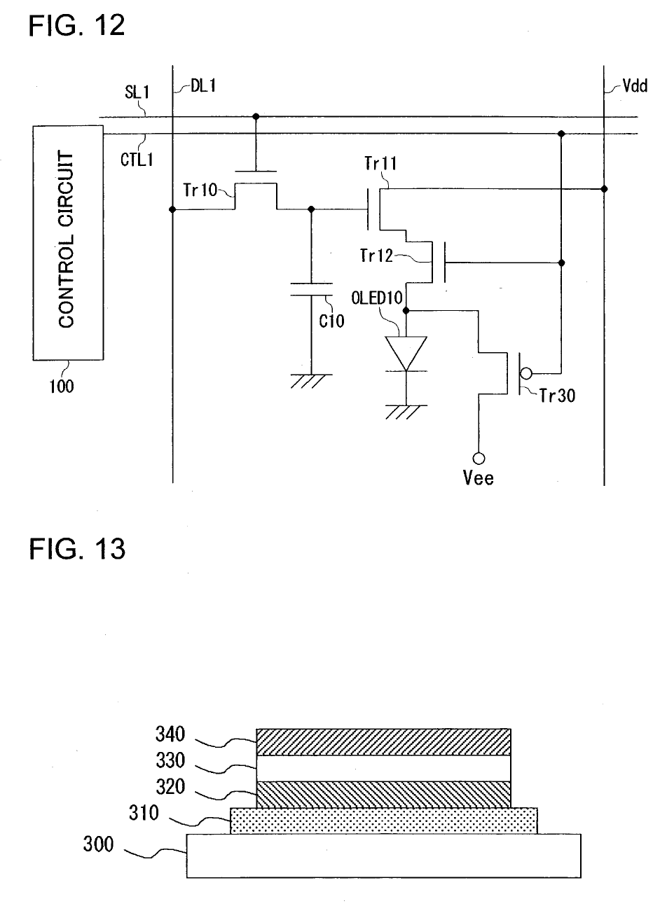

FIG. 11 shows a circuit structure in which the circuit shown in FIG. 1 further includes a bypass circuit therein. A source electrode of a thirteenth transistor Tr30 is connected to negative potential Vee which is lower than the ground potential to which the cathode electrode of the OLED 10 is connected. In a similar manner, FIG. 12 shows a circuit structure in which the circuit shown in FIG. 6 further includes a bypass circuit therein. A source electrode of a thirteenth transistor Tr30 is connected to negative potential Vee which is lower than the ground potential to which the cathode electrode of the OLED 10 is connected. In these circuits shown in FIG. 11 and FIG. 12, when a control signal line CTL1 turns low, a third transistor Tr12 turns off and the thirteenth transistor Tr30 turns on. Then, potential at the anode electrode of the OLED 10 becomes the same as the negative potential Vee. The cathode electrode of the OLED 10 is ground potential, and the potential at the cathode electrode is higher than the potential at the anode electrode, so that the OLED 10 is in a reverse-biased.

By putting the OLED 10 in the reverse-bias applied state accordingly, the electric charge remaining in the OLED 10 can be pulled out and the residual image phenomenon can be suppressed. At the same time, the characteristics of an organic film constituting the OLED 10 can be recovered. As a general problem, the OLED suffers deterioration of the organic film, namely, luminance degradation if used for long period of time, and the deterioration is conspicuous compared to other optical elements utilizing liquid crystals or the like. Thus, by setting the OLED in the reverse-bias applied state during an update period of luminance data, the display quality thereof is prevented from being reduced and at the same time the proper characteristics of the organic film can be restored.

Here, the third transistor Tr12 and the thirteenth transistor Tr30 are on-off controlled by not the scanning line SL1 but the control signal line CTL1. But the arrangement is not limited thereto, and the scanning line SL1 may on-off control the third and thirteenth transistors Tr12 and Tr30, for example.

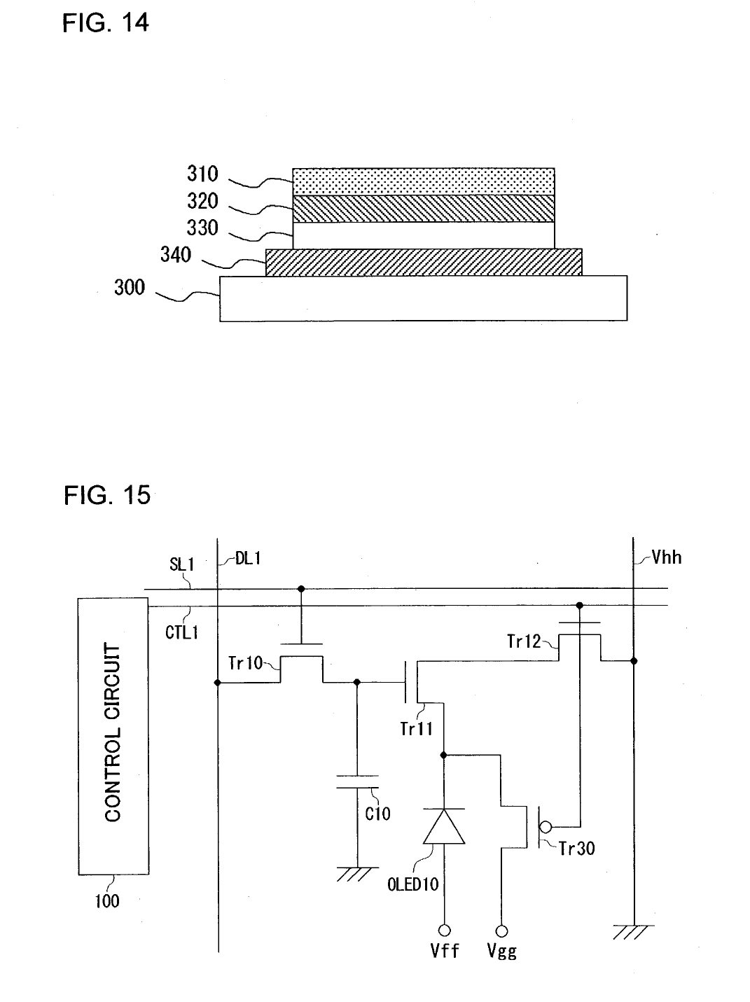

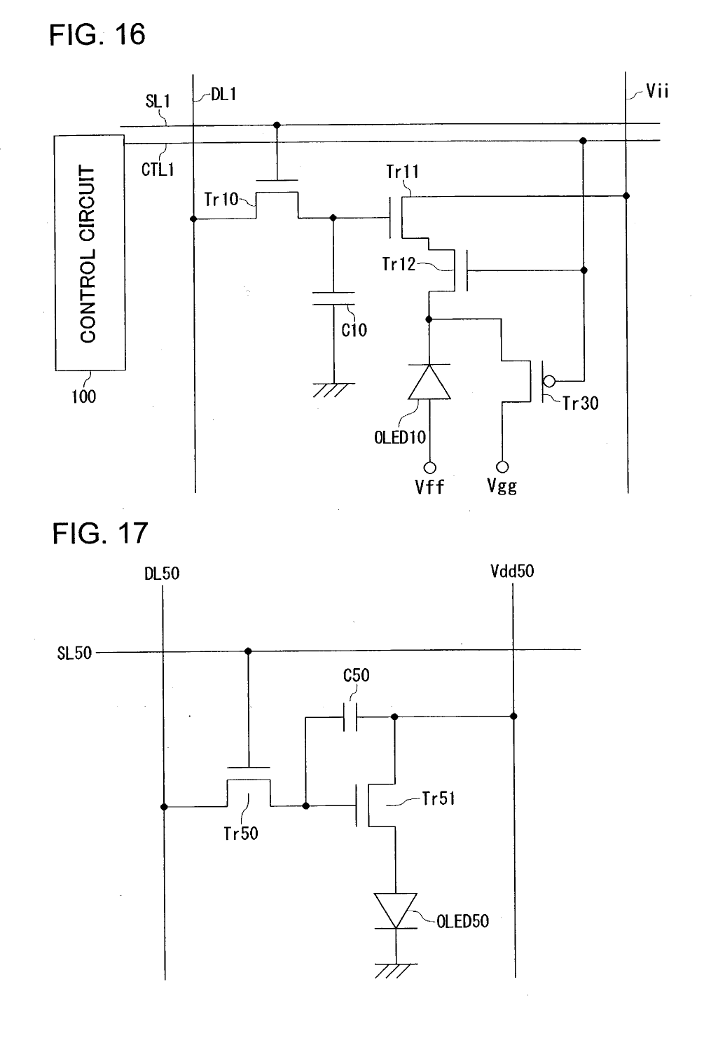

In general, a multi-layer structure of an OLED is such that an anode layer 310, a hole transporting layer 320, an organic EL layer 330 and a cathode layer 340 are stacked, in this order from the bottom to the top thereof, on an insulating substrate such as a glass substrate 300, as shown in FIG. 13. The multi-layer structure of the OLED is not limited to that shown in FIG. 13, and may be such that a cathode layer 340, an organic EL layer 330, a hole transporting layer 320 and an anode layer 310 are stacked, in this order from the bottom to the top thereof, on an insulating substrate such as a glass substrate 300, as shown in FIG. 14. If the multi-layer structure of the OLED is the one as shown in FIG. 13, a cathode of the OLED is connected to ground potential which is fixed potential. On the other hand, if the multi-layer structure of the OLED is the one as shown in FIG. 14, an anode of the OLED is connected the fixed potential. FIGS. 15 and 16 are examples of the pixel circuit suitable for the OLEDs having such multi-layer structures.

FIG. 15 shows a circuit structure for a pixel where the anode and cathode electrodes of the OLED 10 shown in the pixel circuit of FIG. 11 are replaced with the cathode and anode electrodes thereof, respectively, so that the anode electrode is connected to a power supply potential Vff which is both positive potential and fixed potential. Moreover, the electrode, connected to the negative potential Vee, of the thirteenth transistor Tr30 is now connected to a positive potential Vgg which is higher than the power supply potential Vff. Moreover, the electrode, connected to the power supply line Vdd, of the third transistor Tr12 is now connected to a low potential line Vhh which is ground potential.

During the emission time of the OLED 10, the current flows from the power supply potential Vff to the low potential line Vhh which is ground potential, by way of the second transistor Tr11 and the third transistor Tr12. Then, the third transistor Tr12 turns on and the thirteenth transistor Tr30 turns off by turning the control signal line CTL1 low. As the control signal line CTL1 is turned low during the luminance update period of the OLED 10, the third transistor Tr12 turns off and the thirteenth transistor Tr30 turns on. As a result, the potential at the cathode electrode of the OLED 10 becomes positive potential Vgg which is higher than the power supply potential Vff, so that the OLED 10 becomes reverse-biased.

FIG. 16 shows a circuit structure for a pixel where the anode and cathode electrodes of the OLED 10 shown in the pixel circuit of FIG. 12 are replaced with the cathode and anode electrodes thereof, respectively, so that the anode electrode is connected to a power supply potential Vff which is fixed potential. The power supply line Vdd (positive potential) connected to the second transistor Tr11 shown in FIG. 12 is now a negative potential line Vii which is of negative potential. Moreover, the electrode, connected to the negative potential Vee, of the thirteenth transistor Tr30 is now connected to a positive potential Vgg which is higher than the ground potential. As the control signal line CTL1 is turned high during the luminance update period of the OLED 10, the thirteenth transistor Tr30 turns on and the third transistor Tr12 turns off. At this time, the potential at the cathode electrode of the OLED 10 becomes positive potential Vgg which is higher than the power supply potential Vff that represents the potential at the anode electrode thereof, so that the OLED 10 is in a reverse-bias applied state.

In the pixel circuits shown in FIGS. 15 and 16, the third transistor and thirteenth transistors Tr12 and Tr30 are on-off controlled by the control signal line CTL1, but the arrangement is not limited thereto, and the scanning line SL1 may on-off control the third and thirteenth transistors Tr12 and Tr30, for example. In such a case, the structure of transistors will be of a type such that the third transistor Tr12 turns off and the thirteenth transistor Tr30 turns on while the luminance data is being set in the second transistor Tr11.

Although the present invention has been described by way of exemplary embodiments, it should be understood that many changes and substitutions may further be made by those skilled in the art without departing from the scope of the present invention which is defined by the appended claims.

What is claimed is:

1. A display apparatus which includes a shutoff circuit provided between a current-driven optical element and a power supply and which controls said shutoff circuit at timing independent of timing that sets luminance data for said optical element, so that said optical element emits light intermittently.

2. A display apparatus according to claim 1, wherein said shutoff circuit is controlled by a control signal via a path different from a scanning signal that controls timing for setting luminance data to said optical element.

3. A display apparatus, including:
a shutoff circuit which shuts off a current-driven optical element from a power supply; and
a control circuit which controls said shutoff circuit,
wherein said control circuit controls said shutoff circuit at timing independent of timing that sets luminance data for said optical element, so that said optical element emits light intermittently.

4. A display apparatus according to claim 3, wherein a plurality of optical elements constituting a pixel are provided corresponding to a plurality of colors, and said control circuit sets individually on and off duty ratios for the respective plurality of optical elements.

5. A display apparatus according to claim 1, wherein said shutoff circuit includes a drive element which drives said optical element and a capacitance which stabilizes a hold state of luminance data set in said drive element, and wherein said optical element is put to an off state by varying a state of the luminance data via the capacitance.

6. A display apparatus according to claim 2, wherein said shutoff circuit includes a drive element which drives said optical element and a capacitance which stabilizes a hold state of luminance data set in said drive element, and wherein said optical element is put to an off state by varying a state of the luminance data via the capacitance.

7. A display apparatus according to claim 3, wherein said shutoff circuit includes a drive element which drives said optical element and a capacitance which stabilizes a hold state of luminance data set in said drive element, and wherein said optical element is put to an off state by varying a state of the luminance data via the capacitance.

8. A display apparatus according to claim 4, wherein said shutoff circuit includes a drive element which drives said optical element and a capacitance which stabilizes a hold state of luminance data set in said drive element, and wherein said optical element is put to an off state by varying a state of the luminance data via the capacitance.

9. A display apparatus according to claim 1, wherein said optical element is turned off in a manner such that said shutoff circuit shuts off supply of power to said optical element before timing at which the luminance data is set to said optical element.

10. A display apparatus according to claim 3, wherein said optical element is turned off in a manner such that said control circuit so controls that said shutoff circuit shuts off supply of power to said optical element before timing at which the luminance data is set to said optical element.

11. A display apparatus according to claim 1, wherein, prior to causing said optical element to emit light, said shutoff circuit shuts off supply of power to said optical element for a period required during which electric charge remaining in said optical element is eliminated to reduce residual image phenomenon.

12. A display apparatus according to claim 3, wherein, prior to causing said optical element to emit light, said control circuit so controls that said shutoff circuit shuts off supply of power to said optical element for a period required during which electric charge remaining in said optical element is eliminated to reduce residual image phenomenon.

13. A display apparatus according to claim 1, wherein said optical element is an organic light emitting diode.

14. A display apparatus according to claim 3, wherein said optical element is an organic light emitting diode.

15. A display apparatus according to claim 3, wherein said control circuit further outputs a scanning signal which controls timing for setting luminance data to said optical element.

16. A display apparatus according to claim 4, wherein three colors of R, G and B serve as the plurality of colors.

17. A display apparatus according to claim 4, wherein three colors of R, G and B serve as the plurality of colors, and said control circuit sets individually duty ratios for adjusting balance of the three R, G and B colors, to the respective optical elements corresponding to the three R, G and B colors.

18. A display apparatus according to claim 4, wherein three colors of R, G and B serve as the plurality of colors, and said control circuit sets individually duty ratios which correspond to variance of degradation speed caused by difference in material of optical elements utilized for the three R, G and B colors.

19. A display apparatus according to claim 1, wherein said shutoff circuit includes a metal oxide semiconductor transistor.

20. A display apparatus according to claim 3, wherein said shutoff circuit includes a metal oxide semiconductor transistor.
